(19) United States
(12) Patent Application Publication
(10) Pub. No.: US 2018/0202590 A1
(43) Pub. Date: Jul. 19, 2018

(54) GIMBALED FLEXURE FOR SPHERICAL FLEX JOINTS

(71) Applicant: Unison Industries, LLC, Jacksonville, FL (US)

(72) Inventors: Gordon Tajiri, Allentown, PA (US); Jason Levi Burdette, Beavercreek, OH (US); Dattu GV Jonnalagadda, Andra Pradesh (IN); Michael Thomas Kenworthy, Gilbert, AZ (US)

(21) Appl. No.: 15/406,220

(22) Filed: Jan. 13, 2017

(51) Int. Cl. F16L 27/103

(52) U.S. Cl. CPC F16L 27/103

(57) ABSTRACT

A flexible joint assembly for a joint between a first duct and a second duct for providing a flow of fluid, such as bleed air in an aviation implementation. The flexible joint includes a bellows supported by a mounting assembly having a first support and a second support, each surrounding a portion of the bellows. A gimbal ring assembly of the joint assemblies can operably couple the first support and the second support.

### BACKGROUND OF THE INVENTION

Turbine engines, and particularly gas or combustion turbine engines, are rotary engines that extract energy from a flow of combusted gases passing through the engine in a series of compressor stages, which include pairs of rotating blades and stationary vanes, through a combustor, and then onto a multitude of turbine stages, also including multiple pairs of rotating blades and stationary vanes.

Duct assemblies are provided about the turbine engine and provide conduits for the flow of various operating fluids to and from the turbine engine. One of the operating fluids is bleed air. In the compressor stages, bleed air is produced and taken from the compressor via feeder ducts. Bleed air from the compressor stages in the gas turbine engine can be utilized in various ways. For example, bleed air can provide pressure for the aircraft cabin, keep critical parts of the aircraft ice-free, or can be used to start remaining engines. Configuration of the feeder duct assembly used to take bleed air from the compressor requires rigidity under dynamic loading, and flexibility under thermal loading. In one example, feeder duct assembly systems use ball joints or axial joints in the duct to meet requirements for flexibility, which compromise system dynamic performance and increase the weight of the system.

### BRIEF DESCRIPTION OF THE INVENTION

In one aspect, the present disclosure relates to a duct assembly for a turbine engine including a first duct, a second duct, and a flexible joint assembly coupling the first duct to the second duct. The flexible joint assembly includes a bellows having a first end and a second end and convolutions located therebetween and a gimbaled joint assembly. The gimbaled joint assembly includes a first support surrounding the first end of the bellows and a portion of the convolutions and having at least one pin, a second support surrounding the second end of the bellows and a portion of the convolutions and having at least one pin, and a gimbal ring assembly. The gimbal ring assembly operably couples to the at least one pin of the first support and the at least one pin of the second support and has a set of revolute joints interconnected via a ring body. A revolute joint includes a truncated disk operably coupled to the at least one pin of the first support or the second support and where the truncated disk is located within a joint housing and a set of interfacial pads are located between a portion of the truncated disk and the housing.

In another aspect, the present disclosure relates to a joint assembly including a bellows having a first end and a second end and convolutions located therebetween and a gimbaled joint assembly. The gimbaled joint assembly includes a first support ring surrounding the first end of the bellows and a portion of the convolutions, a second support ring surrounding the second end of the bellows and a portion of the convolutions, and a gimbal ring assembly operably coupled to the first support and the second support and having a set of at least four revolute joints interconnected via a ring body. At least some of the set of at least four revolute joints use virtual centers of rotation to offset rotational bending loads on the bellows and where during use a developed internal pressure load is distributed between the set of at least four revolute joints.

In yet another aspect, the present disclosure relates to a joint assembly including a bellows having a first end and a second end and convolutions located there between and a gimbaled joint assembly. The gimbaled joint assembly includes a first support surrounding the first end of the bellows and a portion of the convolutions, a second support surrounding the second end of the bellows and a portion of the convolutions, and a gimbal ring assembly operably coupled to the first support and the second support and having a set of revolute joints interconnected via a ring body. The first support and the second support are configured to pivot relative to each other and where a revolute joint of the set of revolute joints includes at least two surfaces that are configured to make line contact surfaces during use.

### BRIEF DESCRIPTION OF THE DRAWINGS

In the drawings:

FIG. 1 is a schematic cross-sectional view of a gas turbine engine with a bleed air ducting assembly in accordance with various aspects described herein.

FIG. 2 is a perspective view of the bleed air ducting assembly having multiple flex joints in accordance with various aspects described herein.

FIG. 3 is a perspective view of the flex joint of FIG. 2 including four revolute joints in accordance with various aspects described herein.

FIG. 4 is a perspective view of the flex joint of FIG. 3 with caps removed from the four revolute joints in accordance with various aspects described herein.

FIG. 5 is an exploded plan view of the flex joint of FIG. 4 in accordance with various aspects described herein.

FIG. 6 is an exploded view of a gimbal ring assembly including the four revolute joints in and two supports accordance with various aspects described herein.

FIG. 7 is a perspective view of the gimbal ring assembly of FIG. 6 with one revolute joint assembly exploded therefrom in accordance with various aspects described herein.

FIG. 8 is an enlarged view of the revolute joint assembly of FIG. 7, in accordance with various aspects described herein.

FIG. 9 is a cross-sectional view of the revolute joint assembly of FIG. 8 taken across section IX-IX in accordance with various aspects described herein.

FIG. 10 is an exploded view of the revolute joint assembly of FIG. 8 in accordance with various aspects described herein.

FIG. 11 is another exploded view of the revolute joint assembly of FIG. 10 illustrating the opposite side of the components of the revolute joint assembly in accordance with various aspects described herein.

### DESCRIPTION OF EMBODIMENTS OF THE INVENTION

The aspects of present disclosure are directed to providing a joint assembly. Such a joint assembly can be utilized for improved rotational compliance for reduced reaction loading into the case of turbine engines during assembly, operation, and thermal growth of high temperature bleed-air ducting systems. Thus, for purposes of illustration, the present invention will be described with respect to a gas turbine engine. Gas turbine engines have been used for land and nautical locomotion and power generation, but are most commonly used for aeronautical applications such as for airplanes, including helicopters. In airplanes, gas turbine engines are used for propulsion of the aircraft. It will be understood, however, that aspects of the disclosure are not so limited and can have general applicability in non-aircraft applications, such as other mobile applications and non-mobile industrial, commercial, and residential applications. Additionally, the aspects described will have equal applicability to any ducting system experiencing high system loading or large thrust and shear loads requiring a flex joint to connect elements.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine relative to the engine centerline. Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

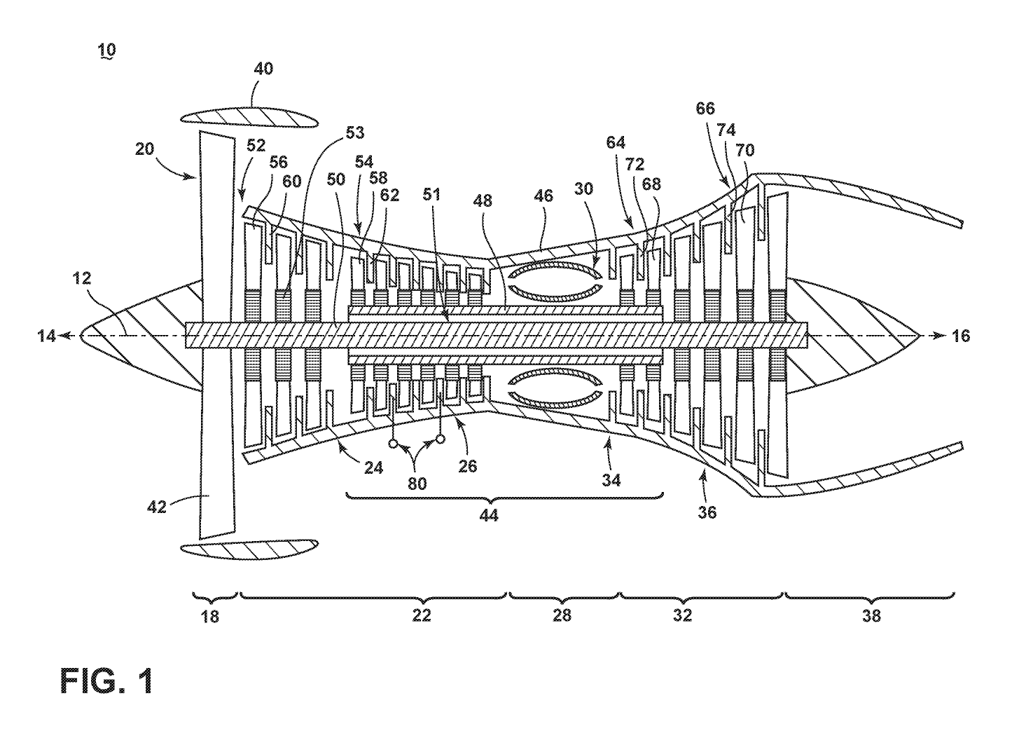

FIG. 1 is a schematic cross-sectional diagram of a gas turbine engine 10 for an aircraft. The engine 10 has a generally longitudinally extending axis or centerline 12 extending from forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a set of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The portions of the engine 10 mounted to and rotating with either or both of the spools 48, 50 are also referred to individually or collectively as a rotor 51.

The LP compressor 24 and the HP compressor 26 respectively include a set of compressor stages 52, 54, in which a set of compressor blades 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible. The blades 56, 58 for a stage of the compressor can be mounted to a disk 53, which is mounted to the corresponding one of the HP and LP spools 48, 50, respectively, with stages having their own disks. The vanes 60, 62 are mounted to the core casing 46 in a circumferential arrangement about the rotor 51.

The HP turbine 34 and the LP turbine 36 respectively include a set of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

In one non-limiting aspect of the disclosure, some of the air from the compressor section 22 can be bled off, extracted, vented, or the like, via one or more bleed air duct assemblies 80, and can be used for cooling engine 10 portions, especially hot portions, such as the HP turbine 34. In another non-limiting example, some of the air from the compressor section 22 can be bled off and used to generate power or run environmental systems of the aircraft, such as the cabin cooling/heating system or the de-icing system. In the context of a turbine engine 10, the hot portions of the engine 10 can be downstream of the combustor 30 or the turbine section 32, with the HP turbine 34 being the hottest portion, as it is directly downstream of the combustion section 28. Air that is drawn off the compressor and used for these purposes is known as “bleed air.”

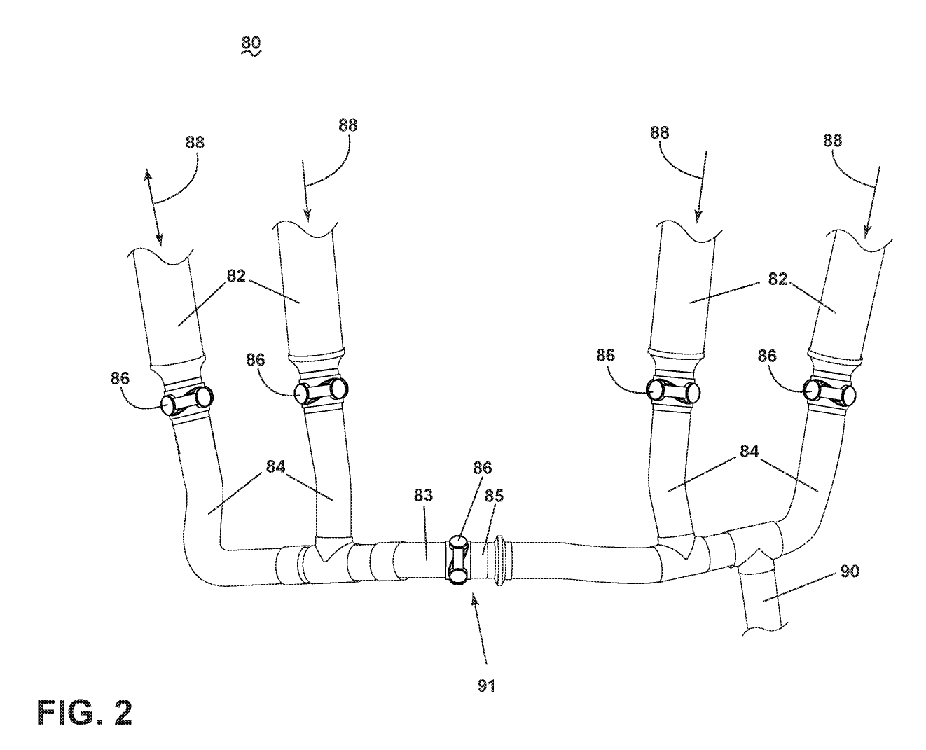

Referring to FIG. 2, an exemplary bleed air duct assembly 80 includes radially inner first ducts 82 and radially outer second ducts 84. As used herein, “radially” is relative to the engine centerline 12 of FIG. 1. The first and second ducts 82, 84 can be fixed in their position relative to the engine 10 or respective engine 10 portions. A joint assembly 86, which can include, but is not limited to, a ball-joint, axial joint, etc. couples the first and second ducts 82, 84. A flow of bleed air 88 can be drawn from the compressor section 22 into the first ducts 82, through the second ducts 84, and provided to an exhaust duct 90 for use in various other portions of the engine 10 or aircraft. As shown a set of connected first and second ducts 82, 84 can be connected in parallel to a common flow duct 91 downstream from the set of connected ducts 82, 84. The common flow duct 91 can further include a an addition and joint assembly 86 coupling third and fourth duct assemblies 83, 85, similar in functionality and operation to the first and second ducts 82, 84, and can fluidly connect the flow of bleed air 88 from the set of connected first and second ducts 83, 85 to a common exhaust duct 90.

While the aspects as described herein will be related to the first and second ducts 82, 84, it should be understood that the joint assembly can have equal applicability to the third and fourth ducts 83, 85 or any other duct system requiring a joint.

During engine 10 operation, the flow of bleed air 88 can operably act to heat and expand portions of the bleed air duct assembly 80. The joint assembly 86 couples the first ducts 82 to the second ducts 84 and provides for reducing or mitigating forces acting on the bleed air duct assembly 80, including but not limited to, vibration or thermal expansion, while providing for operational flexion of the bleed air duct assembly 80. In one non-limiting example, the flex joint provides for transfer of the large thrust and shear loads at the interface between the first and second ducts 82, 84.

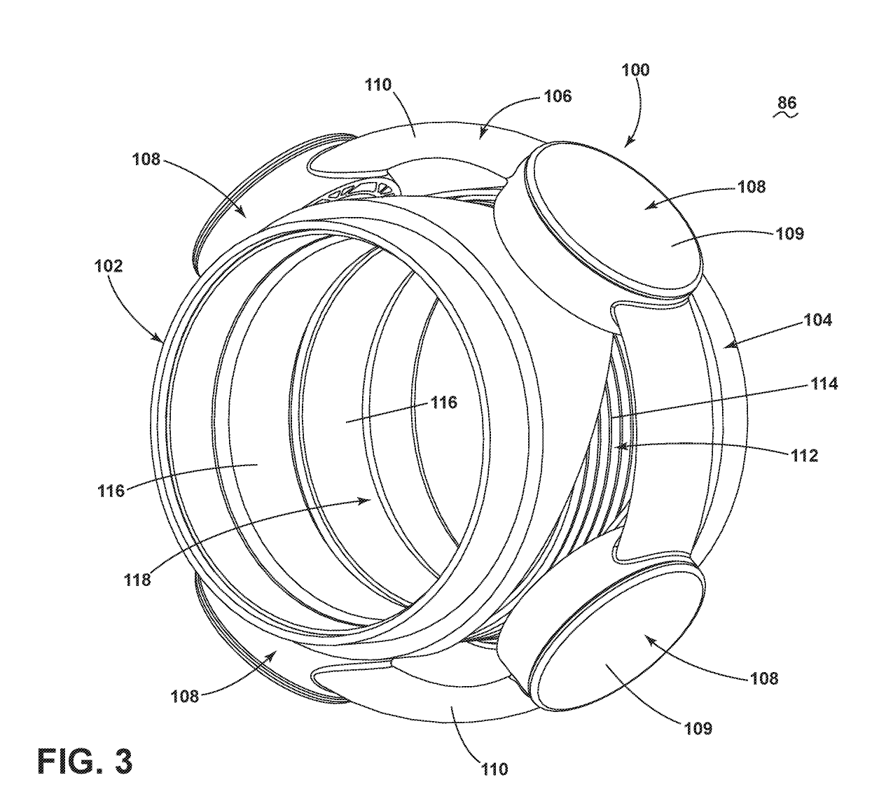

FIG. 3 illustrates an exemplary joint assembly 86. The joint assembly 86 is a gimbaled joint assembly 100 including a first support 102 and a second support 104. A bellows 112 is provided between the first and second supports 102, 104. The bellows 112 includes a set of convolutions 114 configured to provide for the expansion and contraction of the bellows 112. The bellows 112 can be single-layer, dual-layer having a liner, or the like. The bellows 112 and the convolutions 114 can be formed from a ductile material permitting expansion or contraction of the bellows 112. The first and second supports 102, 104 in the illustrated example surround a portion of the convolutions 114.

The gimbaled joint assembly 100 includes a gimbal ring assembly 106. The gimbal ring assembly 106 includes a set of revolute joints 108, illustrated as four revolute joints 108, interconnected by a ring body 110. The revolute joints 108 can include caps 109 covering the interior of the revolute joints 108. The gimbal ring assembly 106 couples the first support 102 to the second support 104 at the revolute joint 108. The revolute joints 108 can be operably coupled to the ring body 110 or can be integrally formed with the ring body 110, such as by additive manufacturing including direct metal laser melting (DMLM), for example.

One or more joint fittings or liners 116 can be provided at the first and second support 102, 104 for connecting the bellows 112 to the first and second support 102, 104. Additionally, the liners 116 can be used to seal the first and second supports 102, 104, or the bellows 112, or a combination thereof, to the first and second ducts 82, 84 (FIG. 2). Alternately or in addition to the liners 116, it is contemplated that the joint can have an integral feature of the shroud supports 102, 104 similar to the liners 116 that can be resistance welded to the bellows 112. In yet another non-limiting example, the liners 116 can be extended to become a flow liner for the bellows 112.

The combination of the first and second support 102, 104, the gimbal ring assembly 106, and the bellows 112 collectively forms a joint interior 118. The joint assembly 86 provides for fluidly interconnecting the first and second ducts 82, 84 (FIG. 2) via the joint interior 118, while bearing large thrust loads and rotational movement at the joint assembly 86.

While not shown, it is contemplated that the joint assembly 86 can be housed within an exterior housing or casing. For example, such a casing can be utilized where it may be undesirable to expose the convolutions 114 of the bellows 112 to the environment. Such a casing can mount to the first and second ducts 82, 84, or the first and second support 102, 104 by way of non-limiting examples.

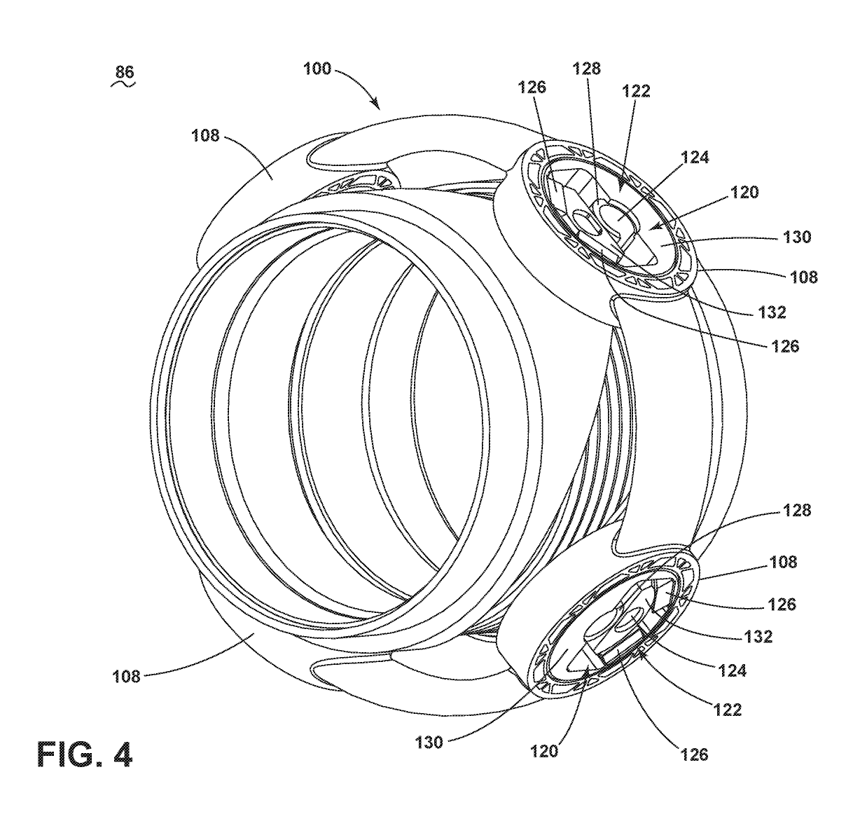

FIG. 4 illustrates the joint assembly 86 of FIG. 3 with the caps 109 removed from the revolute joints 108. The revolute joints 108 include an interior 120 having a revolute joint assembly 122. The revolute joint assembly 122 includes a pin 124, interfacial pads 126, a clip 128, a support disk 130, and a truncated disk 132.

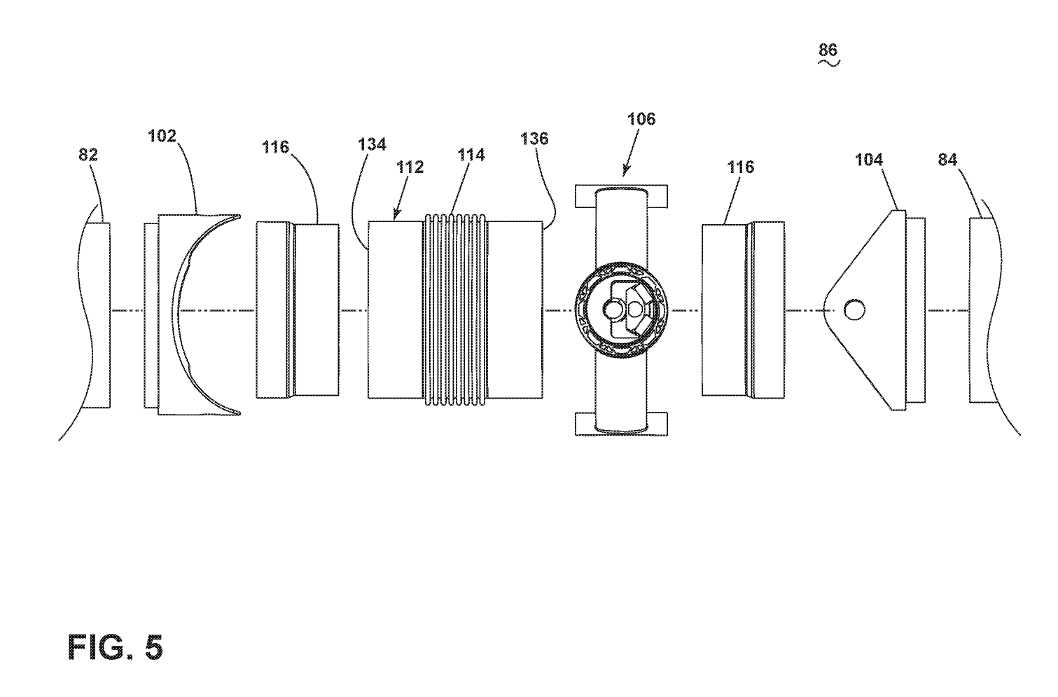

FIG. 5 illustrates an exploded view of the joint assembly 86 in accordance with aspects of the disclosure. When assembled, the first and second supports 102, 104 couple to the gimbal ring assembly 106. The bellows 112, including a first end 134 and a second end 136 on opposing sides of the convolutions 114, fits within the gimbal ring assembly 106 and between the first and second supports 102, 104. The liner 116 can couple the bellows 112 to the first and second support 102, 104. The first end 134 of the bellows 112 and the supports 102, 104 can mount to the first duct 82 and the second duct 84 by a butt weld, for example. Alternatively or additionally, a fillet weld to can be used to couple the bellows 112 to the ducts 82, 84 where the bellows 112 surrounds the ducts 82, 84. The first end 134 of the bellows 112 also couples to the first support 102 and the second end 136 of the bellows 112 couples to the second support 104. Upon coupling the first and second supports 102, 104 to the gimbal ring assembly 106, the bellows 112 is partially encased within the gimbaled joint assembly 100. When coupled, the first support 102 surrounds the first end 134 of the bellows 112 and at least a portion of the convolutions 114, and the second support 104 surrounds the second end 136 of the bellows 112 and at least a portion of the convolutions 114. The first support 102 and the second support 104 can cover different radial positions of the same convolution 114. It should be understood that the particular arrangement of the ducts 82, 84, the bellows 112, and the first and second supports 102, 104 couple to one another is not limited to as described. Any one element can surround another, such that a sealed fluid flow path is defined between the first and second ducts 82, 84 through the joint assembly 86.

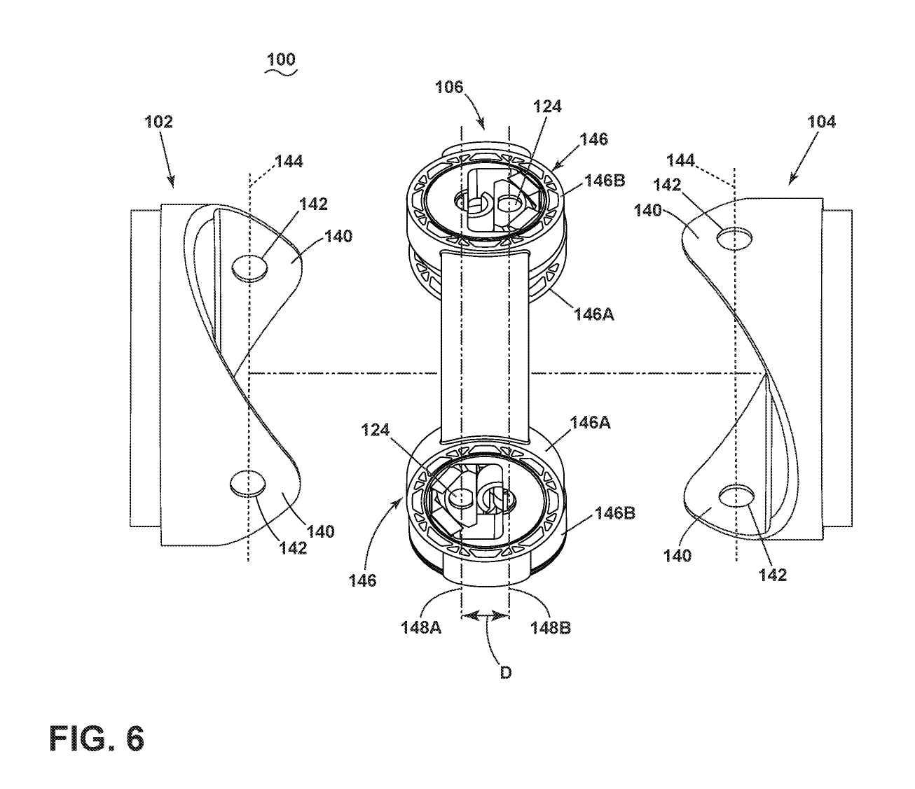

FIG. 6 illustrates the interconnection between the first and second supports 102, 104 and the gimbal ring assembly 106 to form the gimbaled joint assembly 100. Each of the first and second supports 102, 104 have two extensions 140. Each extension 140 includes an aperture 142. The apertures 142 on the extensions 140 of the supports define a support axis 144.

The gimbal ring assembly 106 includes the four revolute joints 108, including two pairs 146 of opposing joints 108 as a first pair 146A and a second pair 146B. Each opposing pair 146 can define a joint axis 148 extending through the pins 124 of each revolute joint 108 in each pair 146 to define a first joint axis 148A and a second joint axis 148B. The joint axes 148A, 148B are offset from one another such that a distance D can be defined between them in an axial direction through the center of the gimbaled joint assembly 100, and extending through the gimbaled joint assembly 100.

The first support 102 can mount to the gimbal ring assembly 106 at the pins 124 defining the first joint axis 148A and the second support can mount to the gimbal ring assembly 106 at the pins 124 defining the second joint axis 148B.

It should be understood that the gimbaled joint assembly with joint axes 148A, 148B as shown is not limited to such an organization. For example, the joint axes 148A, 148B can be on opposite sides, such that the first and second supports 102, 104 overlap one another in the axial direction. In another example, the joint axes 148 can be aligned with one another. Thus, it should be appreciated that gimbaled joint assembly 100 can be tailored to the particular needs of the joint assembly 86.

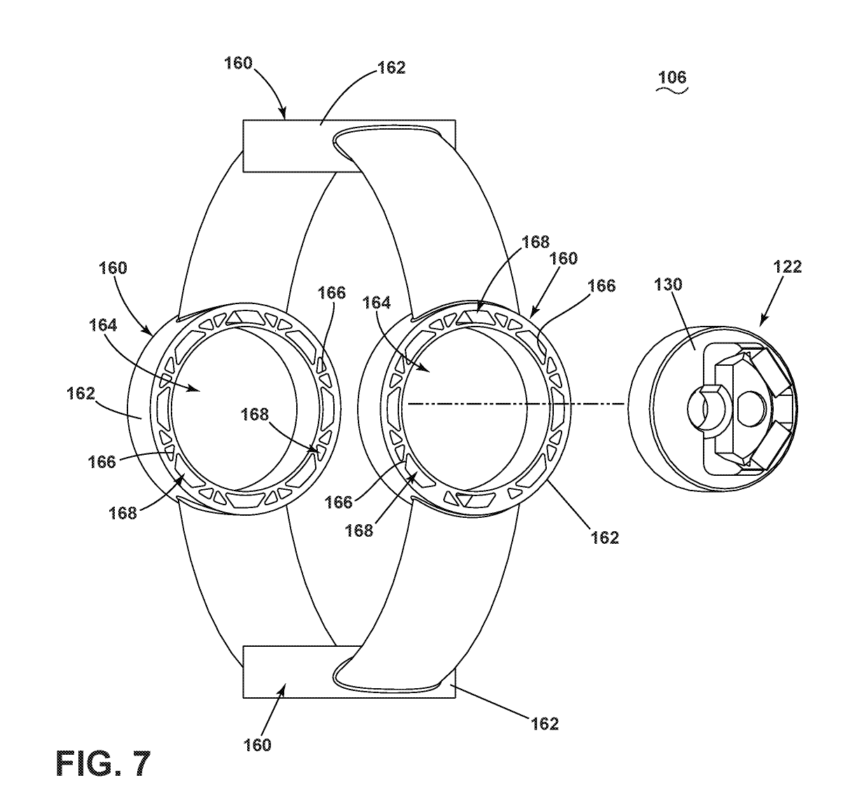

Referring now to FIG. 7, one revolute joint assembly 122 has been exploded from the gimbal ring assembly 106. The gimbal ring assembly 106 includes a set of settings 160, illustrated as four settings 160. Each setting 160 includes an outer ring 162 defining a setting aperture 164. The outer ring 162 can include a set of ribs 166 defining cavities 168. The ribs 166 and cavities 168 provide for structural integrity while minimizing weight. The revolute joint assemblies 122 can mount within the setting 160 by mounting the support disk 130 to the outer ring 162. Such mounting can be accomplished through welding, or can be formed integral with one another, in non-limiting examples.

While the settings 160 are illustrated as four, evenly spaced settings 160, it should be appreciated that the gimbal ring assembly 106 is not so limited. It is contemplated that any number of settings and complementary revolute joint assemblies 122 can be used. Additionally, the settings 160 need not be evenly spaced. Such alternative orientations can be tailored to a particular anticipated bending moment of the particular joint assembly.

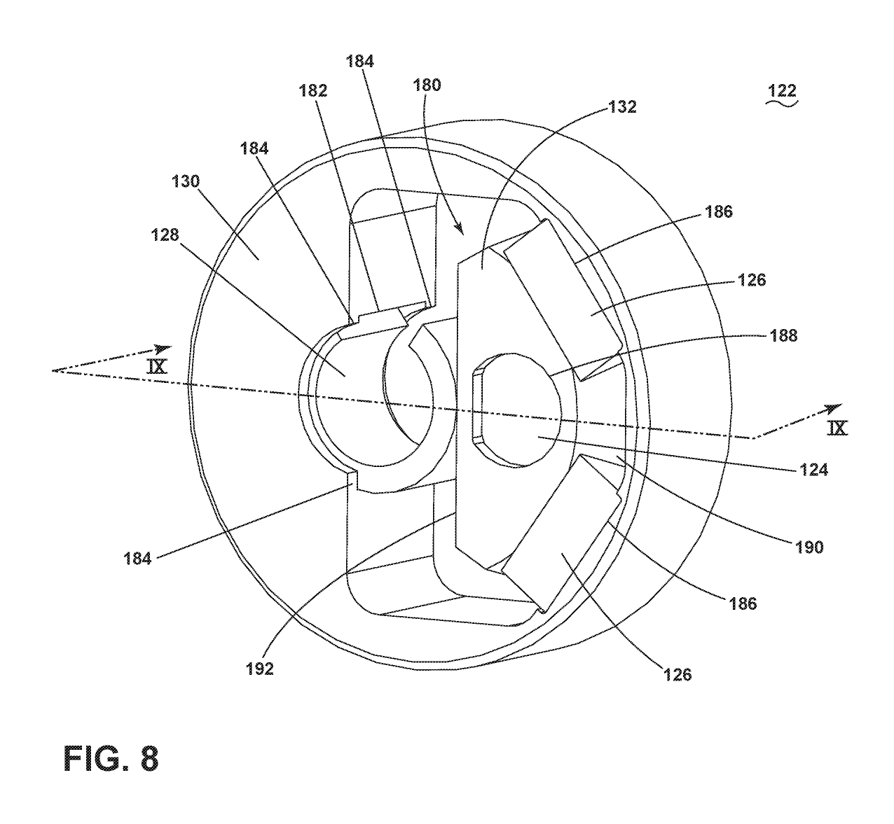

FIG. 8 shows an enlarged view of the revolute joint assembly 122. The support disk 130 includes a central cavity 180. The central cavity 180 includes a clip recess 182. The clip recess 182 includes lips 184 to secure the clip 128 within the clip recess 182. The central cavity 180 further includes two pad recesses 186 adapted to seat the interfacial pads 126. The truncated disk 132 is secured between the interfacial pads 126 and the clip 128. A pin aperture 188 is provided in the truncated disk 132. The pin 124 extends through the pin aperture 188 in the truncated disk 132. The pin 124 can couple to the truncated disk 132 for mounting the revolute joint assembly 122 to the gimbal ring assembly 106 as described herein.

The truncated disk 132 further includes an arcuate face 190 confronting the interfacial pads 126 and a flat face 192 confronting the clip 128. The clip 128 operates as a biasing mechanism to pre-load the truncated disk 132 against the interfacial pads 126. The truncated disk 132 is permitted to pivot about the pin 124 within the central cavity 180. When the truncated disk 132 pivots, the c-clip 128 can rotate within the clip recess 182 to permit pivoting of the truncated disk 132 about one contact surface. The truncated disk 132 can pivot about the pin 124 at the interfacial pads 126 on the opposing contact surface, which are described in detail below. Therefore, the support disk 130 can rotate about the pin 124 via the truncated disk 132.

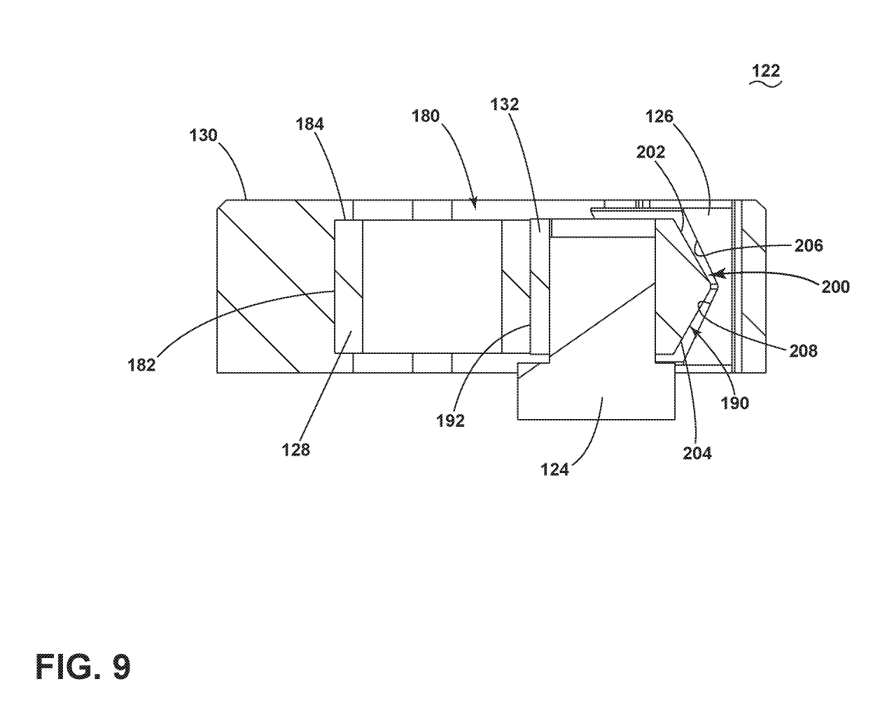

FIG. 9 is a cross-sectional view of the revolute joint assembly 122 taken across section IX-IX of FIG. 8. The interfacial pads 126 include a v-groove 200. The v-groove 200 is configured, machined, designed, adapted, or the like, to conform to the arcuate face 190 of the truncated disk 132. The arcuate face 190 can have a v-shaped profile defining an upper face 202 and a lower face 204. The v-groove 200 can also have an upper face 206 and a lower face 208. As the arcuate face 190 of the truncated disk 132 contacts the v-groove of the interfacial pads, the upper and lower faces 202, 204 of the truncated disk 132 abuts the upper and lower faces 206, 208 of the interfacial pads 126. The abutting/contacting/whatever allows for or provides for the relative movement or rotational movement of the truncated disk 132 relative to the interfacial pads 126.

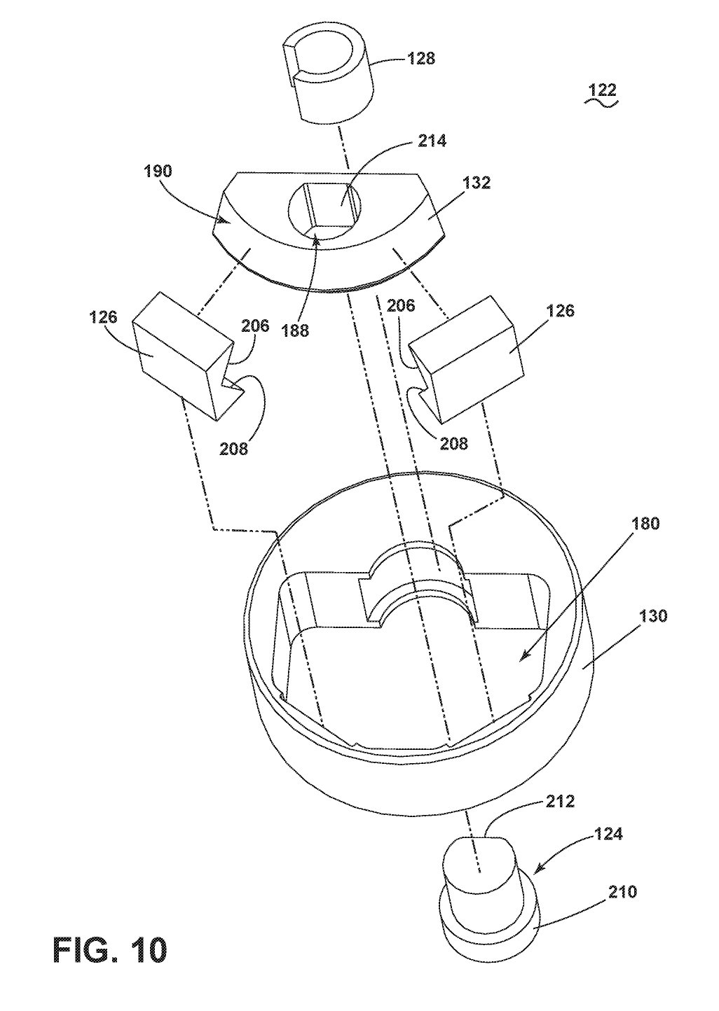

Referring now to FIG. 10, an exploded view of the revolute joint assembly 122 is shown. The pin 124 includes a base 210 and a truncated portion 212. The pin aperture 188 also includes a truncated portion 214. The truncated portion 214 of the pin aperture 188 is keyed, configured, or the like to correspond, align, mate, or assemble with to the truncated portion 212 of the pin 124. As such, when assembled, the rotation of the pin 124 is translated to the truncated disk 132 to rotate within the central cavity 180 of the support disk 130 such that the pin 124 does not rotate independent of, or relative to, the truncated disk 132.

The arcuate face 190 has an arcuate surface and the upper and lower faces 206, 208 of the v-groove are linear. Upon assembly, a single line of contact is formed between the truncated disk 132 and the interfacial pad 126. The arcuate face 190 of the truncated disk 132 can contact and pivot at the interfacial pads 126. As there are two interfacial pads 126 within the revolute joint assembly 122, there will be two lines of contact. Each line of contact can be separated into upper and lower portions at the upper and lower faces 206, 208 of each interfacial pad 126. Therefore, at assembly, four discrete lines of contact between the truncated disk 132 and the interfacial pads 126 are formed.

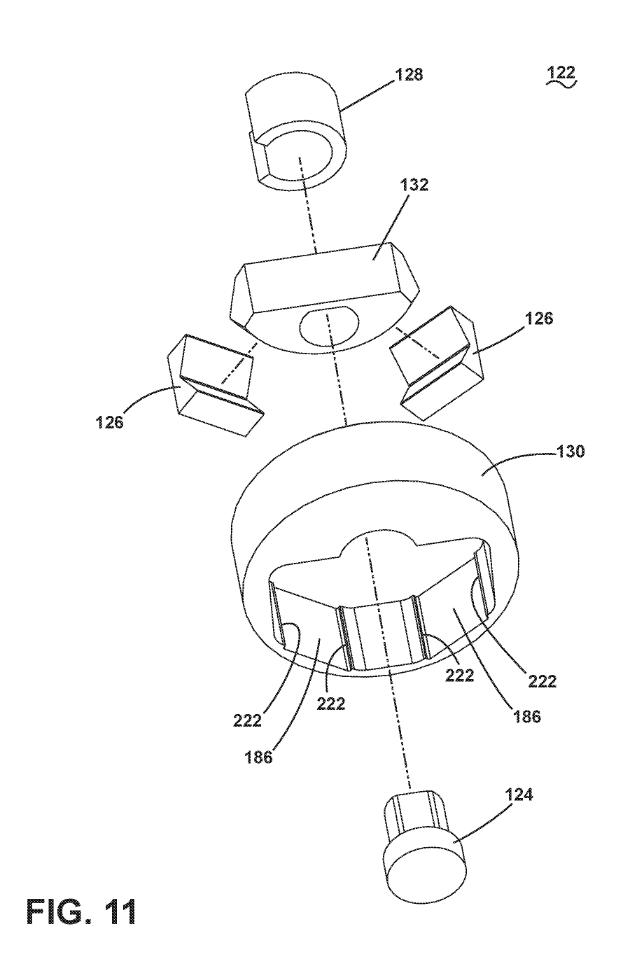

FIG. 11 is another exploded view of the revolute joint assembly 122 taken from the opposing side as that of FIG. 10. As shown, the support disk 130 further includes the two pad recesses 186 adapted to support the interfacial pads 126. The pad recesses 186 define two lips 222 to secure the interfacial pads 126 at the support disk 130. The pad recesses 186 with the lips 222 prevent movement of the interfacial pads 126 during pivoting movement of the truncated disk 132.

In operation, the revolute joint assembly 122 can flexibly pivot about the pin 124. The pin 124 can mount to the first and second supports 102, 104 permitting flexion of the gimbaled joint assembly 100 about the first and second joint axes 148A, 148B of FIG. 6. During flexion, the truncated disk 132 can pivot about the interfacial pads 126, being secured by the clip 128. Pivoting movement of the gimbaled joint assembly 100 about the axes 148A, 148B provides for two rotational degrees of freedom. The each pivotal axes 148A, 148B can rotate between three or four degrees during normal operating conditions, while as much as ten degrees or more is contemplated as a one-time initial installation condition in order to load the joint into the tooling prior to welding of the assembly. Depending on the orientation of the joint assembly during this installation, the maximum total bending from the free-state can be between eight to ten degrees. The relative bending of each of the joints will be a combination to accommodate the installation condition.

The proposed gimbal joint uniquely reduces the bending moment, mass, and maximum bellows stress. The flex join also leverages existing production tooling, advanced additive high-temperature metal 3D print manufacture, and laser welding capabilities. The axial and rotational load paths through the gimbal assembly are through the optimized additive clevis shrouds that cover and protect the bellows. Topographical optimization can be used to minimize the mass by including material selected for minimizing strain energy along the load path. The load path and strain determines the optimized form and shape of the shrouds, devises and gimbal ring. The clevis or yoke interfaces with two sets of oversized truncated disks with matched curvature interface pads. Bending and shear loads are transferred to the central gimbal ring at the interface between the disks and conforming interfacial pads. The low-profile truncated disk with a rigid attachment pin is used to minimize the bending moment effects at the revolute hinge joint assembly. To further minimize twisting of the disk, the v-groove interfaces between the disk and two contact pads are used. The multi-contact small-articulation, plus or minus 5 degrees of rotation, for example, reduces rotational friction, interfacial wear, and overall joint bending moment. The developed internal pressure thrust load is distributed between the four multi-contact revolute joints, two for each rotational degree of freedom. Each of the four joints has two sets of interfacial contact pads with two nearly uniform Hertzian line contact surfaces. The total number of line contact interface surfaces is increased from 4 to 16. Distribution of the thrust load to multiple line-contacts at the interfacial pads reduces the individual interface load magnitudes and associated friction, wear, and joint bending moment.

The joint assembly uniquely utilizes 3D additive high-temperature metal alloy printing to efficiently transfer dynamic system loads with minimum rotational joint stiffness. The joint assembly consists of a truncated large-diameter kinematic revolute disk to minimize the interfacial reaction moments by uniform load distribution at two compliant v-grooved interface pads at each of the four gimbal hinges. This design effectively maximizes overall line contact length and minimizes the peak interfacial pressure load and associated reaction friction force. Conforming kinematic v-grooves in the two interfacial pads increases and improves the uniformity of the Hertzian load distribution at the disk-pad interfaces. Hertz-Steuermann contact stress calculations indicate that the peak normal contact pressure load is directly related to the static and dynamic frictional reaction loads at the interface. The thickness to diameter aspect ratio of the revolute disk will be minimized to increase the interfacial Hertzian contact width and minimize rotational wear and friction. Due to the moment created by the offset of the thrust load of the clevis pins, a non-uniform force distribution exists. Local bending of the clevis at high thrust loads further increases the non-uniform load distribution along the pins. A peak force will exists at the base of the cylindrical pin. This peak force creates high local contact pressure loads and associated high friction and wear. The proposed larger diameter truncated disk with multiple kinematic line contact interfaces significantly reduces surface wear, friction, and joint bending moment.

Low coefficient of friction surface coating material for the truncated disk and interfacial pads based on Hertzian stress calculations can determine thickness, strength, and hardness of the respective components. The base material of the disk and interface pads can be a high temperature alloy. The truncated disks are attached to the clevis of the outer supports with stiff attachment pins. To maintain contact between the disk and the interface pads and create zero-backlash, the c-clip is used and pre-loaded, having an operational compliance operating on the components in the assembly. A pre-load insures the overall kinematic geometry of the unpressurized flex joint during installation assembly. The clip affixes by the truncated disk or lips of the support disk. The cover plates are used to conceal and protect the interface mechanisms from debris and damage. The lightweight 3D printed nickel alloy gimbal ring is optimized for minimal mass and maximum torsional and bending stiffness. This low-mass gimbal ring will have a continuously variable cross-sectional (internal and external) geometry to maximize bending and torsional load capability between and at the revolute joints. Location of internal ribs, gussets, and local changes to wall thickness can be further optimized with finite element analysis. The gimbal ring and location of virtual de-coupled rotational centers for the truncated disks can be analyzed to optimize strength, minimum meridional bending stress, and stability of the bellows.

Additive manufacturing methods, such as 3D printing or direct metal laser melting (DMLM), while other manufacture methods such as casting or molding are contemplated, can be used to make the joint assembly 86 or particular elements thereof.

To the extent not already described, the different features and structures of the various embodiments can be used in combination as desired. That one feature is not illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A duct assembly for a turbine engine, comprising:
a first duct;
a second duct; and
a flexible joint assembly coupling the first duct to the second duct and comprising:
a bellows having a first end and a second end and convolutions located there between; and
a gimbaled joint assembly, comprising:
a first support surrounding the first end of the bellows and a portion of the convolutions and having at least one pin;
a second support surrounding the second end of the bellows and a portion of the convolutions and having at least one pin; and
a gimbal ring assembly operably coupled to the at least one pin of the first support and the at least one pin of the second support and having a set of revolute joints interconnected via a ring body where a revolute joint comprises a truncated disk operably coupled to the at least one pin of the first support or the second support and where the truncated disk is located within a joint housing and where a set of interfacial pads are located between a portion of the truncated disk and the joint housing.

2. The duct assembly of claim 1 wherein the first support and the second support cover different radial positions of a same convolution.

3. The duct assembly of claim 2 wherein the first support and the second support comprise first and second rings with complimentary extensions and at least one pin of the first support is located on one of the complimentary extensions and the at least one pin of the second support is located on another of the complimentary extensions.

4. The duct assembly of claim 1 wherein the set of interfacial pads comprise v-grooves that are configured to conform to the portion of the truncated disk.

5. The duct assembly of claim 1 wherein the first support comprises two pins radially opposite each other and the second support comprises two pins radially opposite each other.

6. The duct assembly of claim 1 wherein a set of at least four revolute joints are interconnected via the ring body and the flexible joint assembly has two rotational degrees of freedom and the first support and second support are configured to pivot relative to each other.

7. The duct assembly of claim 1 wherein at least one revolute joint of the set of revolute joints has a virtual center of rotation that is offset from the center of the revolute joint.

8. The duct assembly of claim 1, further comprising a biasing mechanism operably coupling the truncated disk to the joint housing and pre-loading the truncated disk against the set of interfacial pads.

9. The duct assembly of claim 1 wherein the truncated disk forms multiple kinematic line contact interfaces with the set of interfacial pads.

10. The duct assembly of claim 1 wherein the ring body comprises a variable cross-sectional geometry.

11. A joint assembly, comprising:
a bellows having a first end and a second end and convolutions located there between; and
a gimbaled joint assembly, comprising:
a first support ring surrounding the first end of the bellows and a portion of the convolutions;
a second support ring surrounding the second end of the bellows and a portion of the convolutions; and
a gimbal ring assembly operably coupled to the first support and the second support and having a set of at least four revolute joints interconnected via a ring body;
wherein at least some of the set of at least four revolute joints use virtual centers of rotation to offset rotational bending loads on the bellows and where during use a developed internal pressure thrust load is distributed between the set of at least four revolute joints.

12. The joint assembly of claim 11 wherein the set of at least four revolute joints include two revolute joints for each rotational degree of freedom thereby defining pairs of revolute joints.

13. The joint assembly of claim 12 wherein there are two rotational degrees of freedom.

14. The joint assembly of claim 12 wherein the pairs of revolute joints each have virtual centers of rotation that are offset from the centers of the revolute joints.

15. The joint assembly of claim 11 wherein the revolute joint comprises a truncated disk located off center within a joint housing and where a pin extending into the truncated disk forms the center of rotation for the revolute joint.

16. A joint assembly, comprising:
a bellows having a first end and a second end and convolutions located there between; and
a gimbaled joint assembly, comprising:
a first support surrounding the first end of the bellows and a portion of the convolutions;
a second support surrounding the second end of the bellows and a portion of the convolutions; and
a gimbal ring assembly operably coupled to the first support and the second support and having a set of revolute joints interconnected via a ring body;
wherein the first support and second support are configured to pivot relative to each other and where a revolute joint of the set of revolute joints includes at least two surfaces that are configured to make line contact surfaces during use.

17. The joint assembly of claim 16 wherein the set of revolute joints collectively include 16 line contact interface surfaces.

18. The joint assembly of claim 16 wherein the revolute joint comprises a truncated disk located within a joint housing and where a set of interfacial pads are located between a portion of the truncated disk and the joint housing.

19. The joint assembly of claim 18 wherein the set of interfacial pads comprise v-grooves that are configured to conform to the portion of the truncated disk.

20. The joint assembly of claim 16 wherein the first support and the second support cover different radial positions of a same convolution.
